(19) United States
(12) Patent Application Publication
(10) Pub. No.: US 2009/0301928 A1
(43) Pub. Date: Dec. 10, 2009

(54) Packaging For Lipped Containers

(75) Inventors: Frederick Beauregard, Northbridge, MA (US); John Bergeron, Winchendon, MA (US)

Correspondence Address: MIRICK, O'CONNELL, DEMALLIE & LOUGEE, LLP, 1700 WEST PARK DRIVE, WESTBOROUGH, MA, 01581, US

(73) Assignee: United Comb & Novelty Corporation

(21) Appl. No.: 12/479,023

(22) Filed: Jun. 5, 2009

Related U.S. Application Data
(60) Provisional application No. 61/059,079, filed on Jun. 5, 2008.
(60) Provisional application No. 61/073,806, filed on Jun. 19, 2008.

(51) Int. Cl. B65D 75/02; B31B 1/26

(52) U.S. Cl. 206/784; 493/405

(57) ABSTRACT

A packaging form or blank for one or more lipped containers, where each of the containers has an upper lip that extends outward beyond the periphery of the container body, and where the containers have been placed one inside another to create a nested stack configuration. The form or blank is an elongated, flat construction that defines an opening that is sized and shaped such that when a container body is inserted through the opening, the form rests against the bottom of the lip of the container at the bottom of the stack. When the form is then folded over the stack, the form rests against the top of the lip of the container at the top of the stack. The form or blank also comprises one or more longitudinally-extending sections adapted to be folded to span the space on one side between the form portions that are adjacent to the lips of the containers at the bottom and top of the stack, and laterally-extending flaps that are adapted to be folded to span the spaces between the form portions on two other sides adjacent to the one side, to fully enclose the folded form around the lips of the stack of containers.

### CROSS-REFERENCE TO RELATED APPLICATIONS

This application claims priority to U.S. Provisional Patent Application Ser. No. 61/059,079, entitled “Packaging and Shipping System for Lipped Containers,” filed on Jun. 5, 2008, and to U.S. Provisional Patent Application Ser. No. 61/073,806, entitled “Packaging for Lipped Containers,” filed on Jun. 19, 2008. The entire contents of both applications are expressly incorporated by reference herein.

### FIELD OF THE INVENTION

The invention relates to packaging for shipping lipped containers. More specifically, the invention pertains to corrugated paperboard or cardboard packaging for containers having an upper lip, and particularly where the containers have been stacked inside one another to create a nested stack configuration.

### BACKGROUND OF THE INVENTION

Lipped containers such as tubs, storage containers and the like are typically shipped and stored in cardboard or paperboard boxes, perhaps six or more to a box, depending on the size of the containers. The lipped containers are nested together one inside the other, and then placed together in a box. Because the bodies of the containers project in some cases quite a distance from the lip, the boxes are typically rather large; the minimum height of each box must be equal to the height of one container plus the thicknesses of the lips of the rest of the nested containers. Accordingly, the packaging materials are relatively expensive. In addition, prior to use, the packages themselves may be cumbersome to ship and store and may require multiple steps, including cutting and joining, to assemble.

There is a need in the art, then, for a package for one or more lipped containers that uses less corrugated cardboard or paperboard packaging material, and is therefore less expensive. In addition, there is a need for a package for lipped containers that is easily shipped and stored prior to use, and requires relatively little assembly.

### SUMMARY OF THE INVENTION

This invention features a packaging form or blank for one or more lipped containers, where each of the containers has an upper lip that extends outward beyond the periphery of the container body. In a preferred embodiment, the containers have been placed one inside another to create a nested stack configuration, although the invention may also be used with only one lipped container. The invention comprises an elongated, generally flat construction that defines an opening that is sized and shaped such that when a container body is inserted through the opening, the form rests against the bottom of the upper lip of the container at the bottom of the stack. When the form is then folded over the stack, the form rests against the top of the lip of the container at the top of the stack. The form or blank also comprises one or more longitudinally-extending sections adapted to be folded to span the space on one side between the form sections that are adjacent to the lips of the containers at the bottom and top of the stack, and laterally-extending flaps that are adapted to be folded to span the spaces between the form portions on two other sides adjacent to the one side, to fully enclose the folded form around the lips of the stack of containers.

The packaging forms or blanks of the invention may be stored and shipped flat, requiring relatively little space prior to use, as compared to pre-formed boxes. In addition, the method of assembling the forms or blanks of the invention does not require any cutting, only folding and taping or gluing.

The invention also features a method of using a packaging form or blank for a one or more lipped containers, and a method for the assembly of the packaging form or blank.

In a preferred embodiment, the invention provides a packaging form for a lipped container, where the container comprises a container body and an upper lip that extends outward beyond the periphery of the container body, where the packaging form comprises an elongated, generally flat, blank body comprising four generally rectangular sections; where the first section defines a front edge, first and second opposing sides edges, a rear edge, and a pair of end flaps, one flap foldably coupled to each of the first and second opposing side edges, and where the first section further defines an opening that is sized and shaped to receive the container body such that when the container body is inserted through the opening the first section rests against the bottom of the upper lip of the container; where the second section defines a front edge, first and second opposing side edges, and a rear edge, and the front edge of the second section is foldably coupled to the rear edge of the first section; where the third section defines a front edge, first and second opposing side edges, a rear edge, and a pair of end flaps, one flap foldably coupled to each of the first and second opposing side edges, and the front edge of the third section is foldably coupled to the rear edge of the second section; where the fourth section defines a front edge, first and second opposing side edge, and a rear edge and the front edge of the fourth section is foldably coupled to the rear edge of the third section; where the blank body is folded such that the rear edge of the fourth section is coupled to the front edge of the first section; and where the end flaps are folded so as to fully enclose the folded blank body around the upper lip of the container.

In an aspect, the fourth section further defines a sealing flap foldably coupled to the rear edge of the fourth section, where the sealing flap is folded to couple the sealing flap to the first section. In another aspect, the sealing flap defines one or more slots, and the first section further defines one or more tabs adapted to fit through the slots.

In an aspect, the opening in the first section further comprises one or more projecting portions that are sized and shaped to receive one or more handles on the container. In another aspect, the opening in the first section further comprises a projecting portion that is sized and shaped to receive a pour spout on the container. In yet another aspect, the blank body is folded such that the third section rests against the top of the upper lip of the container.

In an aspect, a plurality of containers may be placed one inside another to create a nested stack configuration, such that when the stack is inserted through the opening, the first section rests against the bottom of the lip of the container at the bottom of the stack, and the end flaps are folded so as to fully enclose the folded blank body around the upper lips of the container in the stack.

In an additional embodiment, the invention provides a method of making a package for a lipped container, where the container comprises a container body and an upper lip that extends outward beyond the periphery of the container body, where the method comprises the steps of: (i) providing an elongated, generally flat, blank body comprising four generally rectangular sections, where the first section defines a front edge, first and second opposing sides edges, a rear edge, and a pair of end flaps, one flap foldably coupled to each of the first and second opposing side edges, and further defines an opening that is sized and shaped to receive the container body such that when the container body is inserted through the opening the first section rests against the bottom of the upper lip of the container, where the second section defines a front edge, first and second opposing side edges, and a rear edge, and the front edge of the second section is foldably coupled to the rear edge of the first section, where the third section defines a front edge, first and second opposing side edges, a rear edge, and a pair of end flaps, one flap foldably coupled to each of the first and second opposing side edges, and the front edge of the third section is foldably coupled to the rear edge of the second section; and where the fourth section defines a front edge, first and second opposing side edge, and a rear edge and the front edge of the fourth section is foldably coupled to the rear edge of the third section; (ii) inserting the container body through the opening until the first section engages the underside of the upper lip; (iii) folding the blank body so as to couple the front edge of the first section to the rear edge of the fourth section; and (iv) folding the first and second pairs of end flaps so as to fully enclose the folded blank body around the upper lip of the container.

In an aspect, the fourth section further defines a sealing flap foldably coupled to the rear edge of the fourth section, and the method further comprises the step of folding the sealing flap so as to couple the sealing flap to the first section. In another aspect, the sealing flap defines one or more slots and the first section defines one or more tabs adapted to fit through the slot, and further comprising the step of the inserting the tabs into the slots.

In an aspect, the opening in the first section further comprises one or more projecting portions that are sized and shaped to receive one or more handles on the container. In another aspect, the opening in the first section further comprises a projecting portion that is sized and shaped to receive a pour spout on the container.

In another aspect, a plurality of containers may be placed one inside another to create a nested stack configuration, where the stack in inserted through the opening until the first section rests against the bottom lip of the upper lip of the container at the bottom of the stack, and the first and second pairs of end flaps are folded to as to fully enclose the folded blank body around the upper lips of the containers in the stack.

In an additional embodiment, the invention provides a packaged assembly, comprising a container comprising a container body and an upper lip that extends outward beyond the periphery of the container body; and an elongated, generally flat, blank body comprising four generally rectangular sections; where the first section defines a front edge, first and second opposing sides edges, a rear edge, and a pair of end flaps, one flap foldably coupled to each of the first and second opposing side edges, and where the first section further defines an opening that is sized and shaped to receive the container body such that when the container body is inserted through the opening the first section rests against the bottom of the upper lip of the container; where the second section defines a front edge, first and second opposing side edges, and a rear edge, and the front edge of the second section is foldably coupled to the rear edge of the first section; where the third section defines a front edge, first and second opposing side edges, a rear edge, and a pair of end flaps, one flap foldably coupled to each of the first and second opposing side edges, and the front edge of the third section is foldably coupled to the rear edge of the second section; where the fourth section defines a front edge, first and second opposing side edge, and a rear edge and the front edge of the fourth section is foldably coupled to the rear edge of the third section; where the four sections are folded such that the rear edge of the fourth section is coupled to the front edge of the first section; and where the end flaps are folded so as to fully enclose the folded blank body around the upper lip of the container.

In an aspect, the opening in the first section further comprises one or more projecting portions that are sized and shaped to receive one or more pour spouts on the container.

In another aspect, the invention a plurality of containers may be placed one inside another to create a nested stack configuration, such that when the stack is inserted through the opening, the first section rests against the bottom of the lip of the container at the bottom of the stack, and the end flaps are folded so as to fully enclose the folded blank body around the upper lips of the container in the stack.

These and other aspects of the invention will become apparent from the following description. In the description, reference is made to the accompanying drawings, which form a part hereof, and in which there are shown preferred embodiments of the invention. Such embodiments do not necessarily represent the full scope of the invention, and reference is therefore made to the claims for understanding the true scope of the invention.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a top view of a form or blank from which a package for a lipped container is formed, according to a preferred embodiment of the invention;

FIG. 2 is a front view of an illustrative example of a lipped container that may be used with the invention of FIG. 1;

FIG. 3 is a perspective view of the form of FIG. 1, and a stack of nested, lipped containers of the type shown in FIG. 2;

FIG. 4 is a perspective view of the stack of containers of FIG. 3 engaged with the form of FIG. 1;

FIG. 5 is a perspective view of the stack of containers and form of FIG. 4, where the form is partially folded along one crease line;

FIG. 6 is a perspective view of the stack of containers and form of FIG. 5, where the form has been partially folded to form a box-like shape with open sides;

FIG. 7 is a perspective view of the stack of containers and form of FIG. 6, where one set of end flaps have been folded and sealed;

FIG. 8 is a perspective view of the stack of containers and form of FIG. 7, where the second set of end flaps have been folded and sealed to form a closed box-like shape; and

FIG. 9 is a top view of a form or blank from which a package for a lipped container having a pour spout is formed, according to an additional embodiment of the invention.

### DETAILED DESCRIPTION OF THE PREFERRED EMBODIMENTS OF THE INVENTION

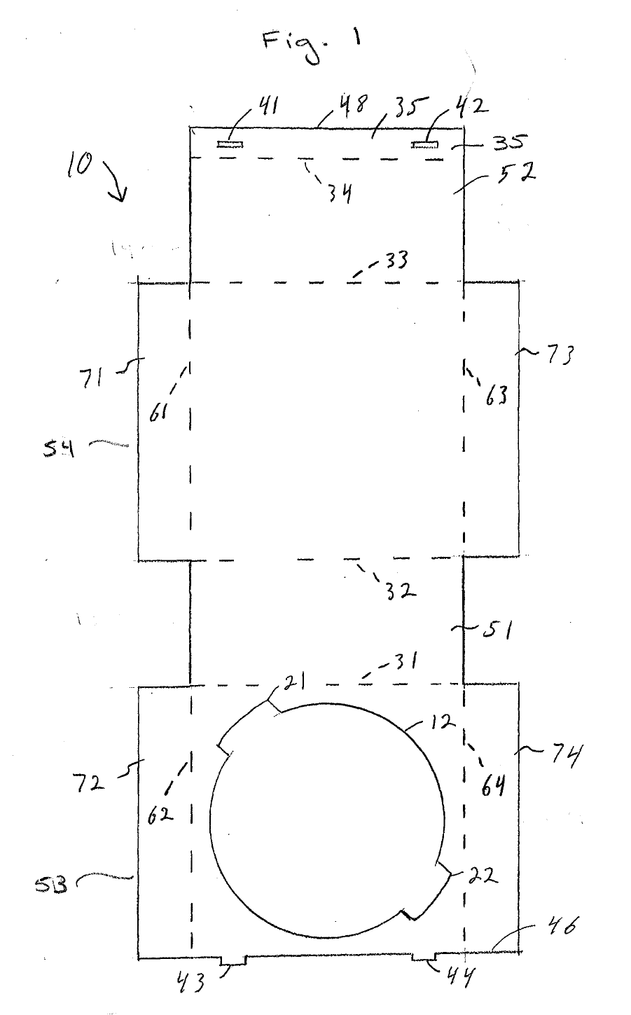

As shown in FIG. 1, in a preferred embodiment, packaging form or blank 10 is an elongated, generally flat construction that is typically stamped or otherwise cut from a sheet of corrugated material. In a preferred embodiment, form or blank 10 is made from corrugated paperboard or cardboard, although the use of corrugated plastic, or non-corrugated paperboard or cardboard, are also contemplated.

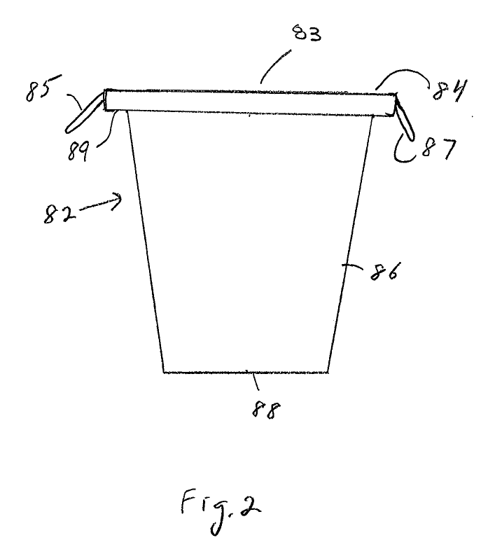

An illustrative example of a lipped container that may be used with the packaging form or blank 10 of FIG. 1 is shown in FIG. 2. Container 82 comprises a hollow frustoconical body 86 having a closed bottom 88 and an open top 83. Container 82 further comprises a protruding upper lip 84 at the top of the container 82, where the protruding upper lip 84 comprises a bottom rim 89. Container 82 may also comprise one or more handles 85 and 87. Container 82 may also comprise one or more pour spouts or outlets (not shown). Note that, in alternate embodiments, the invention applies to any shape or size container with a closed bottom, an open top, and an upper lip that protrudes or extends beyond the container body, i.e., in which the lip projects farther from the central longitudinal axis of the container than does the container body. Further, the invention applies to such containers with or without handles.

In a preferred embodiment, form 10 is assembled such that it is engaged with and covers at least the lips of two or more nested lipped containers, such as containers 82. The assembled form 10 is similar to and shaped like a box, in that it packages the containers. However, the amount of corrugated material is greatly reduced as compared to a traditional box. Note that, in alternate embodiments, form 10 of the invention may be used to package only one lipped container.

With further reference to FIGS. 1 and 2, form 10 defines a first edge 46 and a second edge 48, and four generally rectangular sections, 51, 52, 53 and 54, each section having a front edge, first and second opposing side edges, and a rear edge. The sections are joined longitudinally, with the rear edge of section 53 foldably coupled to and in continuity with the front edge of section 51 at fold or crease 31, the rear edge of section 51 foldably coupled to and in continuity with the front edge of section 54 at fold or crease 32, and the rear edge of section 54 coupled to and in continuity with the front edge of section 52 at fold or crease 33.

With further reference to FIG. 1, section 53 defines a generally circular cutout or opening 12. In a preferred embodiment, circular cutout or opening 12 includes optional projecting portions 21 and 22 configured to provide room for the handles 85 and 87 of the container 82. However, because the containers used with the invention may not comprise handles, as described above, these projecting portions 21 and 22 are not needed in every case. Note also that, in alternate embodiments, projecting portions 21 and 22 may be configured to accommodate handles of different shapes and sizes.

Opening 12 of section 53 has a diameter that is just slightly larger than the greatest diameter of body 86 of container 82 (which in this case, as shown in FIG. 2, is where body 86 meets lip 84), but is smaller than the diameter of lip 84, so that the solid portion of section 53 that is adjacent to opening 12 rests against the bottom 89 of lip 84 when body of container 86 is inserted through opening 12. For containers in which the container body is not circular but perhaps rectangular or another shape, opening 12 has a matching shape such that the container can be inserted through opening 12, but such that the lip rests on section 53 of form 10.

With further reference to FIG. 1, sections 53 and 54 each comprise two end flaps, 72 and 74, and 71 and 73, respectively, foldably coupled to and in continuity with the respective sections' opposing side edges. Specifically, end flaps 72 and 74 are formed by folding section 53 along folds or creases 62 and 64, respectively. Similarly, end flaps 71 and 73 are formed by folding section 54 along folds or creases 61 and 63, respectively. Section 53 further defines a pair of tabs 43 and 44, which are adapted to fit through slots 41 and 42 of section 52. Tabs 43 and 44 are foldably coupled to and coextensive with first edge 46. Section 52 further defines a sealing flap 35, foldably coupled to and coextensive with the rear edge of section 52. Sealing flap 35 is formed by folding section 52 along fold or crease 34. In alternate embodiments, sealing flap 35 may be eliminated, as discussed in detail below.

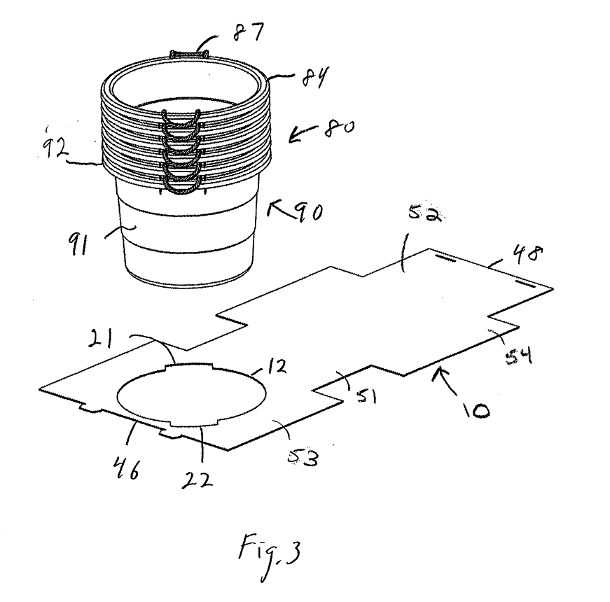

As shown in FIG. 3, stack 80 of containers such as container 82 (in this case stack 80 comprises six nested identical containers 82 including lower container 90 with body 91 and lip 92, and upper container 82 with lip 84 and handles 85 and 87) is shown in place over opening 12 ready to be engaged with form 10 by inserting the body of lower container 90 through opening 12 until form 10 engages the underside of lip 92.

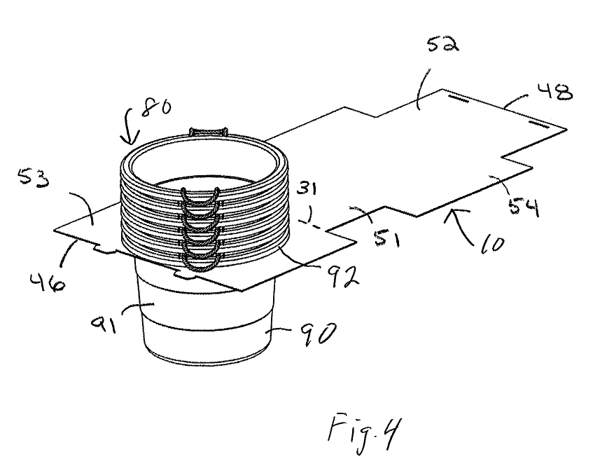

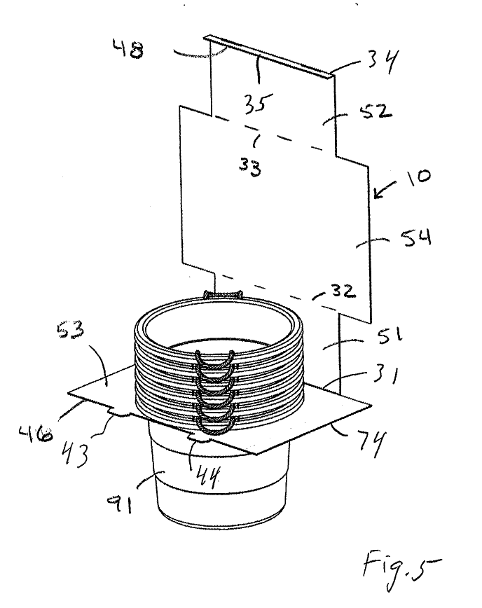

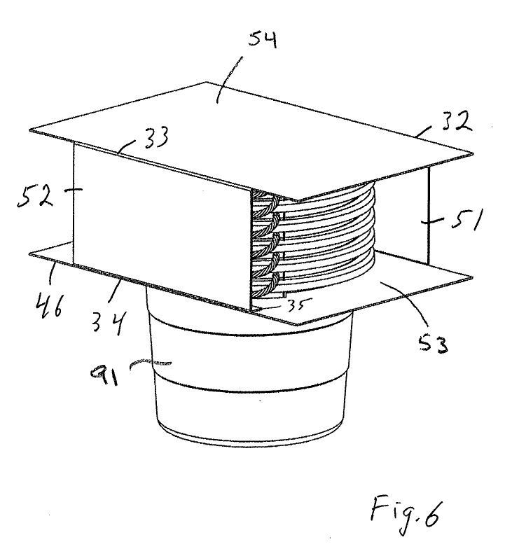

Once form 10 is engaged with stack 80, as shown in FIG. 4, form 10 is folded along fold or crease 31 to the position shown in FIG. 5. Form 10 is then folded along folds or creases 32 and 33 to bring second edge 48 close to first edge 46. Tabs 43 and 44 are folded up so that they can be fit through slots 41 and 42, respectively. Form 10 is also folded along fold or crease 34 to create a sealing flap 35 that rests against the end of form 10 adjacent to first edge 46, as shown in FIG. 6. The result is that section 51 forms one side of what will become a box-like structure, section 52 creates the opposite side, section 54 forms the top, and section 53 forms the bottom of the box-like structure. In a preferred embodiment, the section 54 rests against the top of the lip 84 of container 82, to save packaging material, although this is not required. In alternate embodiments, there may be space between the top of the lip 84 of container 82 and section 54.

Note that in alternate embodiments, fold or crease 34 and sealing flap 35 may be eliminated, and section 52 may be coupled to section 53 by the use of tape, glue or other means known in the art.

In additional embodiments, any or all of the folds or crease could be accomplished with a score line, a perforated line, or a partially-cut line. Further, in alternate embodiments, section 52 could be accomplished by two half-flaps that were folded toward one another and taped closed, with one such half-flap at the location of section 52 and the second at the opposite end, extending outward from first edge 46 (in a similar fashion to edge flaps 71-74 described below).

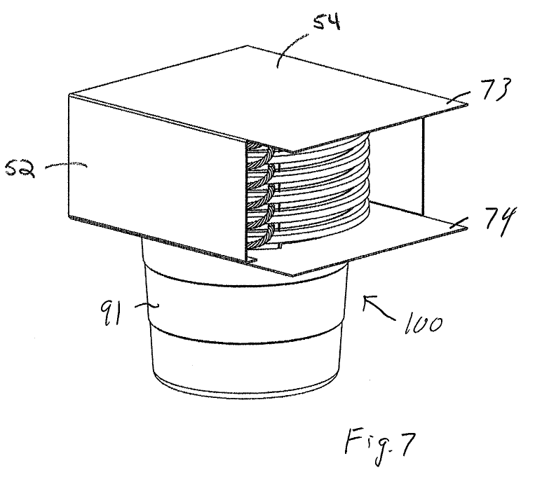

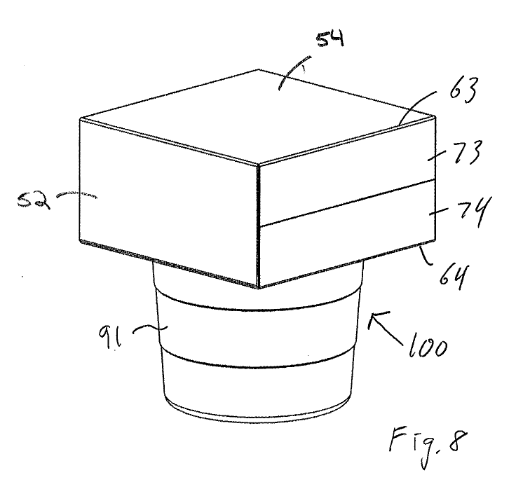

Edge flaps 71, 72, 73 and 74 are then folded toward one another along folds or creases 61, 62, 63 and 64, respectively, and then sealed in place (typically accomplished with tape) to create a closed box-like arrangement, as shown in FIGS. 7 and 8. Note that, in alternate embodiments, the pairs of edge flaps (71 and 73, and 72 and 74) could each be replaced by a single larger flap, similar to the single portion 52, but the preferred embodiment is symmetrical about the longitudinal axis of form 10, which leads to less material waste during manufacturing.

The result is that stack 80 is held together by form 10, to create a compact unit 100, as shown in FIG. 8. Unit 100 has the body 91 of lower container 90 projecting from the lower side thereof.

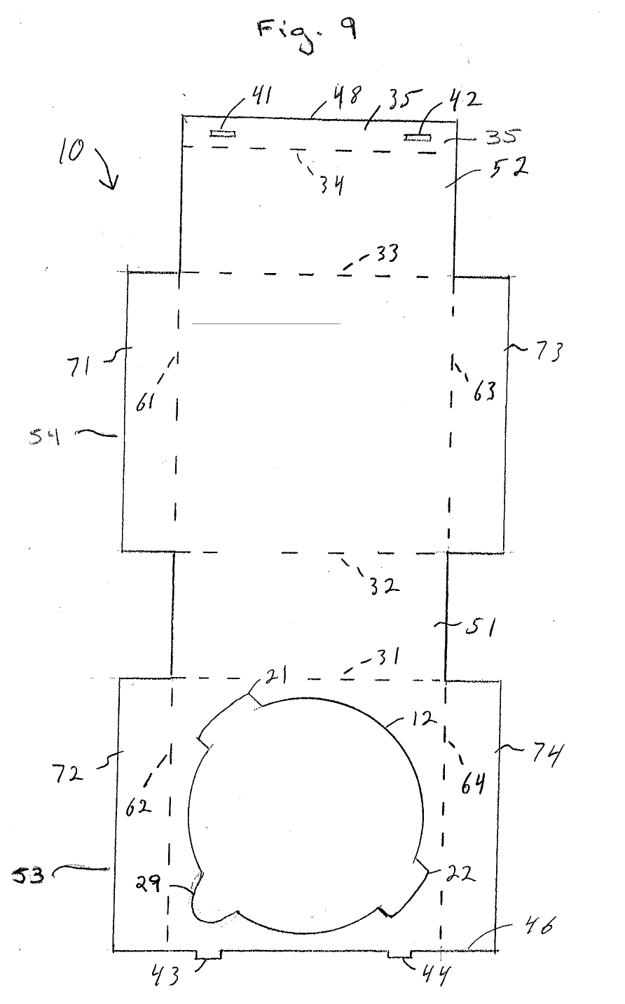

In an additional embodiment, and as shown in FIG. 9, blank or form 10 may further include optional projecting portion 29 configured to provide room for a pour spout or outlet of the container 82.

The inventive form, and the manner in which it is used to engage with a stack of nested containers, thus stores and protects stacks of lipped containers with a substantial reduction in the amount of packaging used, and thus is environmentally sound and cost effective.

The claims should not be read as limited to the described order or elements unless stated to that effect. Therefore, all embodiments that come within the scope and spirit of the following claims and equivalents thereto are claimed as the invention.

It should be understood that the embodiments described herein are exemplary and do not limit the scope of the invention, and that various modifications could be made by those skilled in the art that would fall under the scope of the invention. The scope of the invention is set forth in the claims.

What is claimed is:

1. A packaging form for a lipped container, the container comprising a container body and an upper lip that extends outward beyond the periphery of the container body, the packaging form comprising:
an elongated, generally flat, blank body comprising four generally rectangular sections;
where the first section defines a front edge, first and second opposing sides edges, a rear edge, and a pair of end flaps, one flap foldably coupled to each of the first and second opposing side edges, and where the first section further defines an opening that is sized and shaped to receive the container body such that when the container body is inserted through the opening the first section rests against the bottom of the upper lip of the container;
where the second section defines a front edge, first and second opposing side edges, and a rear edge, and the front edge of the second section is foldably coupled to the rear edge of the first section;
where the third section defines a front edge, first and second opposing side edges, a rear edge, and a pair of end flaps, one flap foldably coupled to each of the first and second opposing side edges, and the front edge of the third section is foldably coupled to the rear edge of the second section;
where the fourth section defines a front edge, first and second opposing side edge, and a rear edge and the front edge of the fourth section is foldably coupled to the rear edge of the third section;
where the blank body is folded such that the rear edge of the fourth section is coupled to the front edge of the first section; and
where the end flaps are folded so as to fully enclose the folded blank body around the upper lip of the container.

2. The packaging form of claim 1, where the fourth section further defines a sealing flap foldably coupled to the rear edge of the fourth section, and where the sealing flap is folded to couple the sealing flap to the first section.

3. The packaging form of claim 2, where the sealing flap defines one or more slots, and the first section further defines one or more tabs adapted to fit through the slots.

4. The packaging form of claim 1, where the opening in the first section further comprises one or more projecting portions that are sized and shaped to receive one or more handles on the container.

5. The packaging form of claim 1, where the opening in the first section further comprises a projecting portion that is sized and shaped to receive a pour spout on the container.

6. The packaging form of claim 1, where the blank body is folded such that the third section rests against the top of the upper lip of the container.

7. The packaging form of claim 1, where a plurality of containers have been placed one inside another to create a nested stack configuration, such that when the stack is inserted through the opening, the first section rests against the bottom of the lip of the container at the bottom of the stack, and the end flaps are folded so as to fully enclose the folded blank body around the upper lips of the container in the stack.

8. A method of making a package for a lipped container, where the container comprises a container body and an upper lip that extends outward beyond the periphery of the container body, the method comprising the steps of:
providing an elongated, generally flat, blank body comprising four generally rectangular sections,
where the first section defines a front edge, first and second opposing sides edges, a rear edge, and a pair of end flaps, one flap foldably coupled to each of the first and second opposing side edges, and further defines an opening that is sized and shaped to receive the container body such that when the container body is inserted through the opening the first section rests against the bottom of the upper lip of the container,
where the second section defines a front edge, first and second opposing side edges, and a rear edge, and the front edge of the second section is foldably coupled to the rear edge of the first section,
where the third section defines a front edge, first and second opposing side edges, a rear edge, and a pair of end flaps, one flap foldably coupled to each of the first and second opposing side edges, and the front edge of the third section is foldably coupled to the rear edge of the second section; and
where the fourth section defines a front edge, first and second opposing side edge, and a rear edge and the front edge of the fourth section is foldably coupled to the rear edge of the third section;
inserting the container body through the opening until the first section engages the underside of the upper lip;
folding the blank body so as to couple the front edge of the first section to the rear edge of the fourth section; and
folding the first and second pairs of end flaps so as to fully enclose the folded blank body around the upper lip of the container.

9. The method of claim 8, where the fourth section further defines a sealing flap foldably coupled to the rear edge of the fourth section, and further comprising the step of folding the sealing flap so as to couple the sealing flap to the first section.

10. The method of claim 9, where the sealing flap defines one or more slots and the first section defines one or more tabs adapted to fit through the slot, and further comprising the step of the inserting the tabs into the slots.

11. The method of claim 8, where the opening in the first section further comprises one or more projecting portions that are sized and shaped to receive one or more handles on the container.

12. The method of claim 8, where the opening in the first section further comprises a projecting portion that is sized and shaped to receive a pour spout on the container.

13. The method of claim 8, where a plurality of containers have been placed one inside another to create a nested stack configuration, where the stack in inserted through the opening until the first section rests against the bottom lip of the upper lip of the container at the bottom of the stack, and the first and second pairs of end flaps are folded to as to fully enclose the folded blank body around the upper lips of the containers in the stack.

14. A packaged assembly, comprising:
a container comprising a container body and an upper lip that extends outward beyond the periphery of the container body; and
an elongated, generally flat, blank body comprising four generally rectangular sections;
where the first section defines a front edge, first and second opposing sides edges, a rear edge, and a pair of end flaps, one flap foldably coupled to each of the first and second opposing side edges, and where the first section further defines an opening that is sized and shaped to receive the container body such that when the container body is inserted through the opening the first section rests against the bottom of the upper lip of the container;
where the second section defines a front edge, first and second opposing side edges, and a rear edge, and the front edge of the second section is foldably coupled to the rear edge of the first section;
where the third section defines a front edge, first and second opposing side edges, a rear edge, and a pair of end flaps, one flap foldably coupled to each of the first and second opposing side edges, and the front edge of the third section is foldably coupled to the rear edge of the second section;
where the fourth section defines a front edge, first and second opposing side edge, and a rear edge and the front edge of the fourth section is foldably coupled to the rear edge of the third section;
where the four sections are folded such that the rear edge of the fourth section is coupled to the front edge of the first section; and
where the end flaps are folded so as to fully enclose the folded blank body around the upper lip of the container.

15. The assembly of claim 14, where the opening in the first section further comprises one or more projecting portions that are sized and shaped to receive one or more pour spouts on the container.

16. The packaged assembly of claim 14, where a plurality of containers have been placed one inside another to create a nested stack configuration, such that when the stack is inserted through the opening, the first section rests against the bottom of the lip of the container at the bottom of the stack, and the end flaps are folded so as to fully enclose the folded blank body around the upper lips of the container in the stack.
